(19) United States
(12) Patent Application Publication
(10) Pub. No.: US 2005/0152600 A1
(43) Pub. Date: Jul. 14, 2005

(54) Method and apparatus for performing handwriting recognition by analysis of stroke start and end points

(75) Inventors: Yen-Fu Chen, Austin, TX (US); John W. Dunsmoir, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/756,918

(22) Filed: Jan. 14, 2004

(51) Int. Cl. G06K 9/00

(52) U.S. Cl. 382/187

(57) ABSTRACT

A method, computer program product, and a data processing system for collecting handwritten characters and performing handwriting recognition based on parameters calculated from strokes of the handwritten characters. Stroke start and end events are identified and stroke parameters are calculated from coordinates of the stroke start and end events. One or more candidate characters are identified based on the stroke parameters.

### RELATED APPLICATIONS

The present application is related to commonly assigned and co-pending U.S. patent application Ser. No. ______ (Attorney Docket No. AUS920031038US1) entitled “METHOD AND APPARATUS FOR REDUCING REFERENCE CHARACTER DICTIONARY COMPARISONS DURING HANDWRITING RECOGNITION”, filed on ______, and to commonly assigned and co-pending U.S. patent application Ser. No. ______ (Attorney Docket No. AUS920031045US1) entitled “METHOD AND APPARATUS FOR SCALING HANDWRITTEN CHARACTER INPUT FOR HANDWRITING RECOGNITION” and hereby incorporated by reference.

### BACKGROUND OF THE INVENTION

1. Technical Field

The present invention relates generally to an improved data processing system and in particular to a method and apparatus for performing handwriting recognition. Still more particularly, the present invention provides a method and apparatus for enabling a server to efficiently recognize a handwriting specimen based on character stroke parameters calculated from stroke start and end points that are supplied to the server by a client.

2. Description of Related Art

In the field of handwriting recognition, various approaches have been taken by software vendors to provide more accurate recognition of handwriting samples. Written languages that have large character sets, e.g., the Chinese and Korean languages, are particularly problematic for software vendors to develop efficient handwriting recognition algorithms. The Chinese language, for example, includes thousands of characters. Accordingly, a reference character dictionary for performing handwriting recognition of the Chinese language necessarily includes thousands of entries. The data size of the characters maintained in the reference dictionary limits the efficiency for performing handwriting analysis of written Chinese characters.

Current handwriting recognition solutions require sampling handwritten character strokes throughout input of the character stroke. For example, many handwriting recognition algorithms require construction of an image, such as a bitmap, of the handwritten character for interrogation of a reference character dictionary. Construction of a bitmap image of the handwritten character requires numerous samples of the handwritten input to be taken during entry of the character. Such techniques are data-intensive and require large amounts of sample data to be gathered from the user input.

Handwriting recognition algorithms are often deployed on portable computational devices such as personal digital assistants (PDAs). The limited storage and computational power of such devices necessitates relatively simple handwriting recognition algorithms. It is desirable to reduce the amount of data necessary for performing handwriting recognition on devices having limited computational abilities.

It is desirable to deploy handwriting recognition algorithms for processing handwritten user input at websites on the Internet. The ability to receive handwritten user input may be advantageous for deployment on e-commerce websites, distance learning web sites, and the like. To enable concurrent service to numerous clients, the amount of data required for performing the handwriting analysis needs to be minimized to reduce latency effects associated with delivery of the handwriting data from the client to the server performing the handwriting analysis.

It would be advantageous to minimize the data necessary for performing handwriting analysis. Moreover, it would be advantageous to have an improved method, apparatus, and computer instructions for collection of handwritten character data and analysis of the data such that the amount of data required for recognition of the handwritten character is reduced. It would further be advantageous to provide a technique for allowing a handwriting recognition algorithm to be executed remotely from an apparatus performing collection of handwritten characters.

### SUMMARY OF THE INVENTION

The present invention provides a method, computer program product, and a data processing system for collecting handwritten characters and performing handwriting recognition based on parameters calculated from strokes of the handwritten characters. Stroke start and end events are identified and stroke parameters are calculated from coordinates of the stroke start and end events. One or more candidate characters are identified based on the stroke parameters.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram of a computer interface for accepting handwritten character input and displaying candidate characters in accordance with a preferred embodiment of the present invention;

FIG. 5 is a flowchart of the processing performed by a client for collecting handwritten character strokes according to a preferred embodiment of the present invention;

FIG. 6 is a flowchart of stroke parameter calculations performed by the client in accordance with a preferred embodiment of the present invention;

FIG. 7 is a diagram illustrating calculation of stroke parameters by the client according to a preferred embodiment of the present invention;

FIG. 8 is a flowchart of processing performed by a handwriting recognition algorithm executed by a server according to a preferred embodiment of the present invention;

FIG. 9 is a diagrammatic illustration of reference character dictionary records used for identifying candidate characters in accordance with a preferred embodiment of the present invention;

FIG. 10A is a diagram illustrating a capture area and candidate display in a computer interface after user input of a first character stroke in accordance with a preferred embodiment of the present invention;

FIG. 10B is a diagram illustrating the capture area and candidate display described in FIG. 10A after user input of a second character stroke in accordance with a preferred embodiment of the present invention;

FIG. 11A is a diagram of a character that requires three constituent strokes when properly written in accordance with a preferred embodiment of the present invention;

FIG. 11B is a diagram illustrating a stroke of the character described in FIG. 11A as entered into the capture area of the computer interface in accordance with a preferred embodiment of the present invention; and

FIG. 11C is a diagram illustrating a partitioning of the stoke described in FIG. 11B in accordance with a preferred embodiment of the present invention.

### DETAILED DESCRIPTION OF THE PREFERRED EMBODIMENT

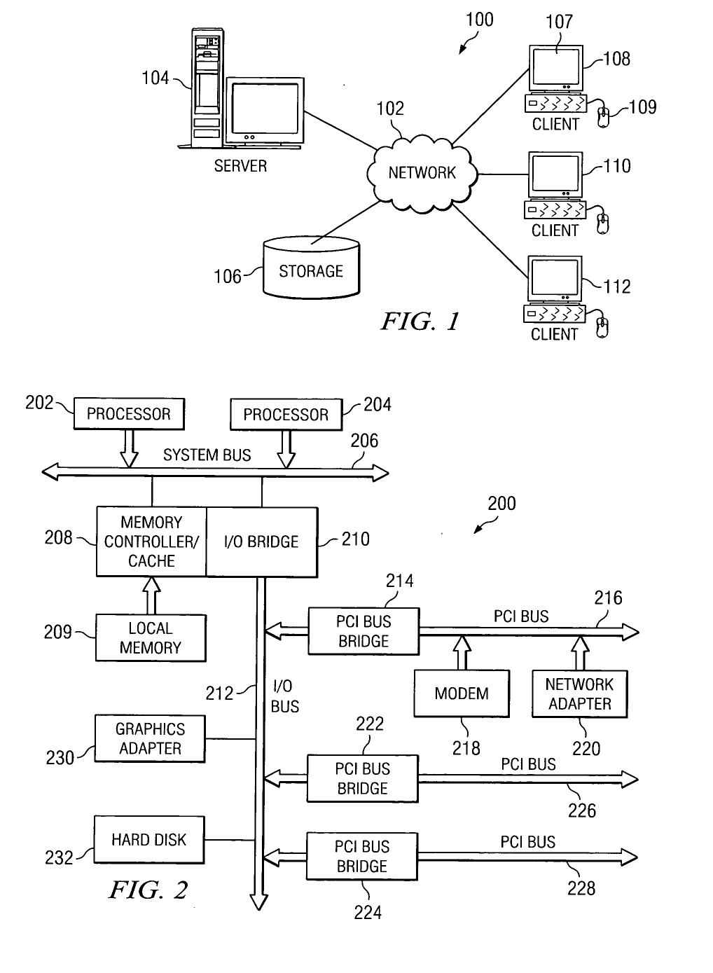

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, a personal computer or network computer. In the depicted example, server 104 provides data, such as HTML documents and attached scripts, applets, or other applications to clients 108, 110, and 112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, including thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention. Server 104 as illustrated is a web server, also referred to as a HTTP server, and includes server software that uses HTTP to serve up HTML documents and any associated files and scripts when requested by a client, such as a web browser. The connection between client and server is usually broken after the requested document or file has been served. HTTP servers are used on Web and Intranet sites.

Referring to FIG. 2, a block diagram of a data processing system that may be implemented as a server, such as server 104 in FIG. 1, is depicted in accordance with a preferred embodiment of the present invention. Data processing system 200 is an example of a computer that may be used to analyze parameters calculated from handwritten character strokes obtained from one or more of clients 108, 110, and 112. More specifically, data processing system 200 supplies data that is processed by a client for providing a computer interface on a display device by which a user of the client provides handwritten character input through the use of a pointing device. In the illustrative examples, an application provided to the client by data processing system 200 derives parameters from character strokes input by the user and communicates the parameters to data processing system 200. Responsive to receipt of the parameters, data processing system 200 identifies one or more candidate characters and communicates the candidate characters to the client.

A stroke parameter defines an attribute of the stroke input by the user and is compared with a corresponding attribute of a stroke of a reference character in a reference character dictionary by the server. For example, a stroke length parameter may be determined by the client that provides a numerical measure of the length of a handwritten character stroke input by the user. The stroke length parameter is communicated to the server and compared with a reference length parameter of a reference character stroke and a numerical measure is obtained indicating an amount of correspondence between the length of the handwritten character stroke and the length of the reference character stroke. A stroke angle parameter may be determined by the client that provides a numerical measure of the trajectory at which the handwritten character stroke was input. The stroke angle parameter is communicated to the server and compared with a reference angle parameter of a reference character stroke and a numerical measure is obtained indicating an amount of correspondence between the angle of the handwritten character stroke and the angle of the reference character stroke. A center parameter may be determined by the client that identifies a position or coordinate of a center point of the handwritten character stroke. The center parameter is communicated to the server and may be compared with other center parameters of handwritten character strokes to determine a positional relation among the strokes. The positional measure of the handwritten character strokes based on comparison of stroke center parameter may be compared with center parameter relations among reference character strokes to determine a numerical correspondence between the relative position of handwritten character strokes and the relative position of reference character strokes. An angle parameter, length parameter, and center parameter are collectively referred to herein as a stroke parameter set.

Results of the length, angle and center parameter comparisons are then evaluated to determine a correspondence between the handwritten character stroke and the reference stroke. The process is repeated by the server for the remaining reference characters of the reference character dictionary. One or more of the reference characters are identified as potential matches with the character being input and are communicated to the client.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108, 110 and 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly. System 200 runs a handwriting recognition algorithm in accordance with an embodiment of the invention as described more fully below.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

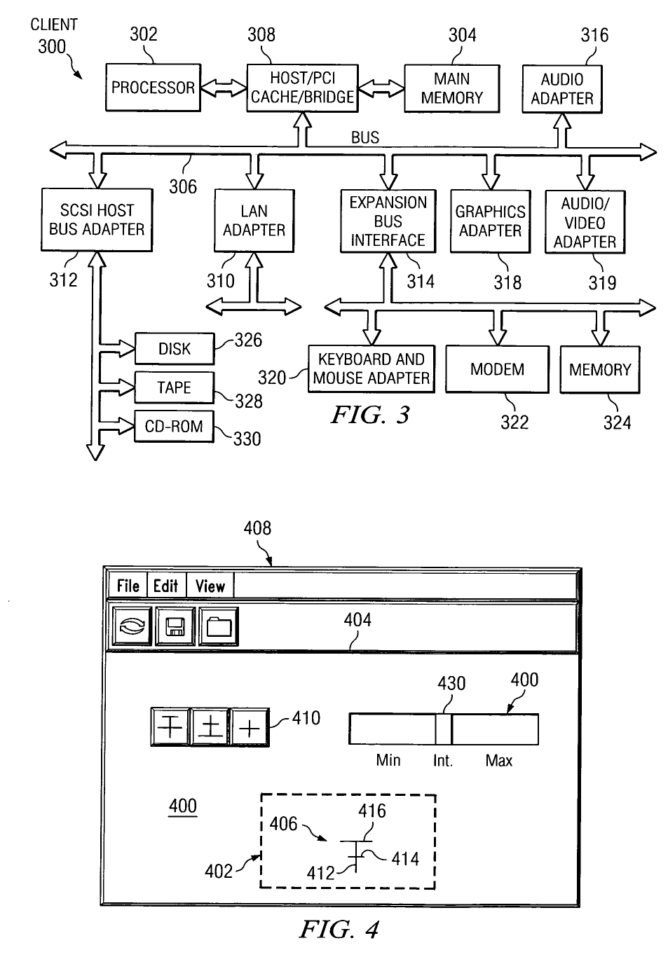

With reference now to FIG. 3, a block diagram illustrating a data processing system is depicted in which the present invention may be implemented. Data processing system 300 is an example of a client computer, such as client 108 in FIG. 1, which may be used for receiving a handwritten character from a user and for calculating stroke parameters of the handwritten character. More particularly, data processing system 300 receives a web page download from system 200 and, responsive to processing of the web page download, displays a computer interface for input of handwritten characters. Each character stroke of a handwritten character is evaluated for stroke start and end events. Data processing system 300 calculates one or more stroke parameters upon determination of the stroke start and end events. Responsive to calculation of the stroke parameters, data processing system 300 communicates the stroke parameters to data processing system 200 for submission to the handwriting recognition algorithm executed by system 200. A candidate character identified by system 200 is communicated to data processing system 300 and the user is able to confirm a match between the character being supplied to the client computer interface and the candidate character identified by system 200. Additional stroke parameters are calculated as the user continues supplying character strokes to the client computer interface and are communicated to system 200 for further handwriting analysis until a candidate character is confirmed as a match by the user of data processing system 300.

Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Graphics adapter 318 drives a display device 107 that provides the computer interface, or GUI, for displaying handwritten characters as supplied by the user. Expansion bus interface 314 provides a connection for a keyboard and mouse adapter 320, modem 322, and additional memory 324. A pointing device such as mouse 109 is connected with adapter 320 and enables supply of pointer input to system 300 by a user. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

The term “mouse”, when utilized in this document, refers to any type of operating system supported graphical pointing device including, but not limited to, a mouse, track ball, light pen, stylus and touch screen or touch pad, and the like. A pointing device is typically employed by a user of a data processing system to interact with the data processing system's GUI. A “pointer” is an iconic image controlled by a mouse or other such devices, and is displayed on the video display device of a data processing system to visually indicate to the user icons, menus, or the like that may be selected or manipulated.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Data processing system 300 runs a web browser adapted to execute a character stroke collection algorithm in accordance with an embodiment of the invention. Preferably, the stroke collection algorithm is distributed to system 300 as a Java applet when the browser downloads a document, e.g., an HTML-encoded web page, from system 200. Accordingly, the browser executed by data processing system 300 may be implemented as any one of various well known Java enabled web browsers such as Microsoft Explorer, Netscape Navigator, or the like.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a depiction of a GUI 400 output on display device 107 when a client connects with server 104 in accordance with a preferred embodiment of the present invention. GUI 400 is displayed responsive to the client processing a web page communicated from server 104. GUI 400 is preferably displayed in window 404 of a web browser interface 408. As illustrated in FIG. 4, GUI 400 includes capture area 402 for display of handwritten characters supplied to the client and candidate characters identified and communicated to data processing system 300 by data processing system 200 according to embodiments of the invention. The user supplies handwritten characters to capture area 402 via a pointing device such as mouse 109. Additionally, GUI 400 includes candidate character display 410 for display of the most recently determined candidate characters and for receiving confirmation of a candidate character match by the user.

In the illustrative example, a complete Chinese character 406 is shown entered into capture area 402. Input of character 406 requires a number of hand strokes. The particular character shown requires input of three strokes 412, 414, and 416. The stroke collection algorithm executed by the client detects the beginning and end of each character stroke supplied to capture area 402. Upon detection of a completed stroke, stroke parameters are calculated from the detected stroke. The stroke parameters are communicated to data processing system 200 for identification of one or more candidate characters that may match the user input as described more fully below.

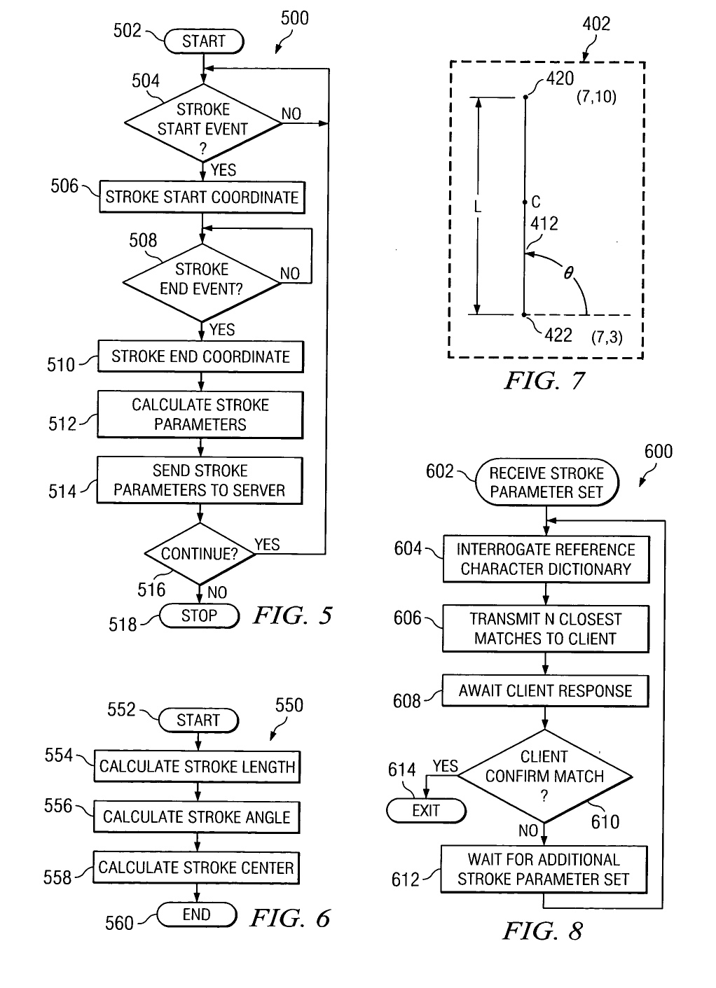

FIG. 5 is a flowchart of the processing performed by the stroke collection algorithm executed by the client according to a preferred embodiment of the invention. The stroke collection algorithm is initiated (step 502) and proceeds to poll for a stroke start event (step 504). In the depicted example, a stroke start event is a pointing device “down” event, such as depression of a mouse button. Upon detection of a stroke start event, the stroke collection algorithm temporarily records a coordinate of the stroke start event (step 506) and proceeds to poll for a stroke end event (step 508). In the illustrative examples, a stroke end event is a pointing device “up” event such as release of a mouse button.

Upon detection of the stroke end event, a coordinate of the stroke end event is read (step 510) and stroke parameters are calculated (step 512). The stroke parameters are communicated to data processing system 200 for analysis by the handwriting recognition algorithm (step 514). An evaluation of whether to continue is made (step 516), and the routine returns to polling for a stroke start event. Otherwise, the routine exits (step 518).

FIG. 6 is a flowchart 500 of processing performed by the stroke collection algorithm in accordance with an embodiment of the invention. The processing steps shown and described in FIG. 6 correspond to step 512 of FIG. 5. Calculation of the stroke parameters is initiated upon detection of a stroke start event and subsequent stroke end event (step 552). A stroke length parameter is calculated from stroke start and end point coordinates (step 554). For example, pointer icon coordinates corresponding to the stroke start and end events may be algebraically processed to determine a linear “length” measure between the stroke start and end points. Additionally, a stroke angle parameter is calculated through, for example, trigonometric relations of the stroke start and end coordinates and provides a directional measure of the stroke (step 556). A stroke center parameter is preferably calculated (step 558) and may be derived from the stroke length and angle parameters and one of the stroke start and end event coordinates. Upon calculation of the stroke parameters, the stroke parameter calculation algorithm exits (step 560).

FIG. 7 is a diagram illustrating calculation of stroke parameters by the stroke collection algorithm according to a preferred embodiment of the invention. A stroke start event is detected in response to a suitable command provided to a pointing device such as mouse 109. For example, a stroke start event may be detected in response to a mouse “down” event, or initiation of a mouse drag operation by depression of a mouse 109 button, while the mouse pointer is located within collection area 402. Alternatively, a stroke start event may be determined in response to a stylus down event detected on a touch pad if handwritten characters are provided to a touch pad. A start point 420 of stroke 412 is identified and corresponds to the mouse position when the stroke start event is detected. Alternatively, start point 420 corresponds to a stylus position on a touch pad when the stroke start event is detected. As mouse 109 is moved, stroke 412 is displayed within capture area 402 according to the movement of the mouse supplied by the user. A stroke end event is detected in response to a suitable command provided to mouse 109 such as a mouse “up” or button release event. Alternatively, the stroke end event may be detected in response to a stylus up event detected on a touch pad if handwritten characters are provided to a touch pad. An end point 422 of stroke 412 is identified and corresponds to the mouse or stylus position when the stroke end event is detected.

A coordinate system, e.g., a Cartesian coordinate system, is used for tracking the position of the mouse and associating respective coordinates with start and end points 420 and 422. In the present example, stroke 412 has start point 420 with an x-coordinate of 7 and a y-coordinate of 10. Stroke 412 has end point 422 with an x-coordinate of 7 and a y-coordinate of 3. After the start and end point pair of stroke 412 are detected, one or more stroke parameters are derived from the start and end point coordinates for submission to the handwriting recognition algorithm running on data processing system 200. In accordance with a preferred embodiment of the invention, a stroke length parameter (L), a stroke angle parameter (θ), and a stroke center parameter (C) are calculated from the start and end point coordinates. For example, the stroke length may be calculated by algebraic manipulation of the start and end point coordinates. The stroke angle parameter is derived from the start and end point coordinates, for example by a computer-implemented trigonometric relation between the coordinates of stroke start and end points 420 and 422.

Additionally, the stroke center parameter is calculated by a computer-implemented trigonometric computation using one of the start and end point coordinates, the stroke length parameter and the stroke angle parameter as operands. The stroke center parameter is a coordinate of a calculated center point of stroke 412. In the preferred embodiment, the stroke parameters are calculated by approximating the stroke as a linear motion. Accordingly, all stroke parameters may be derived using only the stroke start and end point coordinates. The stroke parameters, collectively referred to herein as a stroke parameter set, calculated from the stroke coordinates are transmitted to data processing system 200 by way of network 102.

Notably, the stroke collection algorithm running on client system 300 does not wait until character completion by the user before attempting to identify the character being input by the user. Accordingly, communication of a stroke parameter set derived from one stroke input may be made to data processing system 200 concurrently with supply of a subsequent stroke by the user. Preferably the stroke collection algorithm described with reference to FIGS. 5-7 is implemented as a Java applet that is downloaded as a Web page attachment when data processing system 200 connects with data processing system 300.

FIG. 8 is a flowchart 600 of processing performed by the handwriting recognition algorithm executed by data processing system 200 according to a preferred embodiment of the invention. The handwriting recognition algorithm is initiated upon receipt of a stroke parameter set from the client system (step 602). A reference character dictionary look-up is performed responsive to receipt of the stroke parameter set (step 604). The reference character dictionary may be, for example, implemented as a table, file system, or another suitable data structure. In general, the reference character dictionary comprises attributes of each character of the dictionary that are able to be matched with stroke parameters calculated from the user supplied handwritten character strokes.

More particularly, the reference character dictionary includes attributes of each stroke, such as stroke length, angle, and center parameters. Stroke length, angle, and center parameters of a reference character stroke are collectively referred to herein as a reference parameter set. The reference parameters maintained in the reference character dictionary for a particular reference character entry are compared with a corresponding stroke parameter of the stroke parameter set communicated to the server by the client. A numerical measure, or match probability, of a correspondence between the stroke parameter set and reference parameter sets is generated for one or more of the reference characters defined in the reference character dictionary.

A number N of possible character matches, or candidate characters, are retrieved from the reference character dictionary and are communicated to system 300 (step 606). The number of candidate characters retrieved from the reference character dictionary may be coded into the handwriting recognition algorithm or may be provided by the client.

Alternatively, character entries of the reference character dictionary having respective reference parameters that result in match probabilities in excess of a predefined threshold may be selected as candidate characters for communication to the client. Data processing system 200 awaits a response from the client (step 608). An evaluation of whether the client confirms any of the candidate characters as a match with the character being input is made (step 610).

If the client provides a response that none of the N candidate characters correspond to the handwritten character being input or fails to confirm a candidate character match, handwriting recognition processing proceeds to await for receipt of an additional stroke parameter set (step 612). Another interrogation of the reference character dictionary is performed upon receipt of an additional stroke parameter set.

If the client response confirms one of the N candidate characters as a character match corresponding to the handwritten character, the handwriting recognition processing terminates (step 614). Thus, the reference character dictionary interrogation continues for each stroke of the character supplied by the user until a candidate character obtained by the handwriting recognition algorithm is confirmed as a match by the user. Preferably, the handwriting recognition algorithm illustrated and described with reference to FIG. 8 is implemented as a Java servlet.

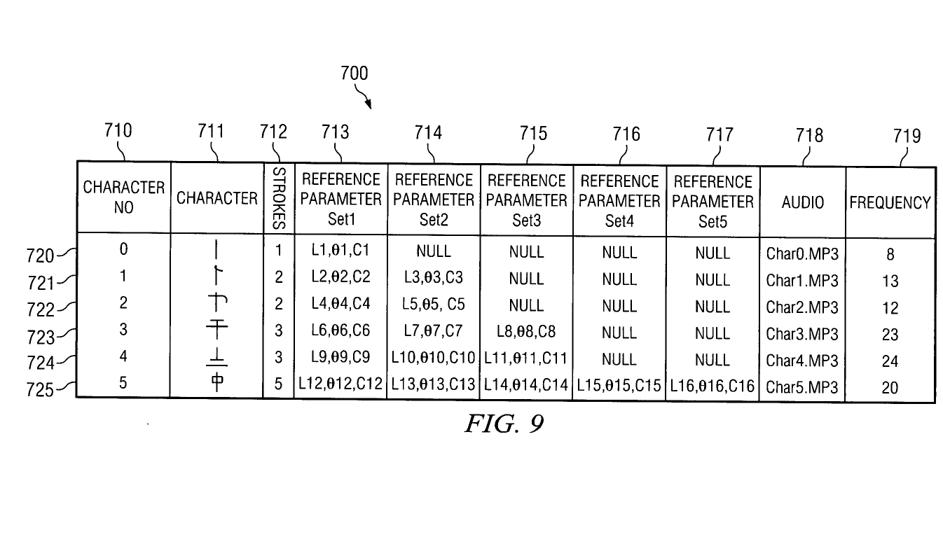

FIG. 9 is a diagrammatic illustration of records 720-725 of reference character dictionary 700. Typically, a reference character dictionary of Chinese characters will have thousands of records. The records shown and described are chosen only to facilitate an understanding of the invention. Reference character dictionary 700 is implemented as a table having records 720-725 that respectively include data elements in respective fields 710-719, but other data structures may be suitably substituted. Fields 710-719 typically have a name, or identifier, that facilitates insertion, deletion, querying, and processing of other data operations or manipulations of dictionary 700. In the illustrative example, fields 710, 711, and 712 have respective labels of character number, character, and strokes. Fields 713-717 are labeled reference parameter set1-reference parameter set5, respectively. Fields 718 and 719 have respective labels of audio and frequency in this example. Reference parameter set fields 714-717 contain reference parameter sets for respective records 720-725.

Each record 720-725 contains a unique index number in key field 710 for distinguishing a particular record from other dictionary 700 entries. Addressing a particular record via an associated key field 710 value is referred to herein as indexing of the record. The character field 711 includes image data of the reference character defined by respective records 720-725. For example, record 723 has an image file, or a reference to an image file such as an address of the image file, in character field 711 that corresponds to the handwritten character supplied to the computer interface described with reference to FIG. 4.

Strokes field 712 contains the number of character strokes of the character defined by respective records 720-725. For example, the character having attributes defined by record 723 consists of a vertical stroke and two horizontal strokes, and strokes field 712 accordingly contains the value of three in record 723.

Reference parameter set fields 713-717 include a reference parameter set for each stroke of the character described by respective records 720-725. Reference parameter set fields 713-715 of record 723, for instance, respectively include a reference parameter set of a stroke of the character defined by record 723, and reference parameter set fields 716 and 717 are nulled.

Audio field 718 may be included in dictionary 700 that contains, or references, an audio file that is an audio recording of a correct pronunciation of the character defined in respective records 720-725. Additionally, audio files of field 719 may contain or reference an audio recording of a correct usage of the respective character. For example, the characters of the Chinese dictionary may form a word or part of a word. The audio files of audio field 718 may include an audio recording of the associated Chinese character used in a word or sentence.

Frequency field 719 contains a data element that identifies a usage frequency of the character defined in respective records 720-725. For example, occurrence frequencies of individual characters may be obtained by surveying various literature and a numerical data element indicating the occurrence frequency is entered into frequency field 719 of respective records 720-725. The frequency data elements of frequency field 719 may be used as a comparison criteria by the handwriting recognition algorithm when two or more candidate characters have similar comparison results, that is when the comparison of two or more candidate character parameter sets with a stroke parameter set results in match probabilities within a predefined threshold or within a specified amount of each other. In the illustrative example, the characters defined by records 720-725 have frequency values of 8, 13, 12, 23, 24, and 20, respectively. The handwriting recognition algorithm may use the character frequency values of frequency field 719 as a comparison criteria when identifying a candidate character to communicate to the client.

Upon receipt of a stroke parameter set, system 200 interrogates the reference dictionary. In general, the handwriting recognition algorithm cycles through the entries of dictionary 700 and compares the stroke parameters of the stroke parameter set with corresponding parameters of the reference parameter set. For example, the length parameter of the stroke parameter set is compared with the length parameter of reference parameter sets of the reference character dictionary. Likewise, the angle and center parameters of the stroke parameter set are compared with respective angle and center parameters of reference parameter sets. Match probabilities are generated in response to the comparison of the stroke parameter set with the reference parameter sets. In response to an evaluation of the match probabilities, one or more candidate characters are selected by the server and returned to data processing system 300 for display in candidate character display 410. For example, data processing system 200 may communicate to the client images as identified in character field 711 of the three reference character dictionary entries having the highest match probabilities obtained from the dictionary interrogation. Additionally, audio files of the candidate characters may be communicated to the client with the candidate character images.

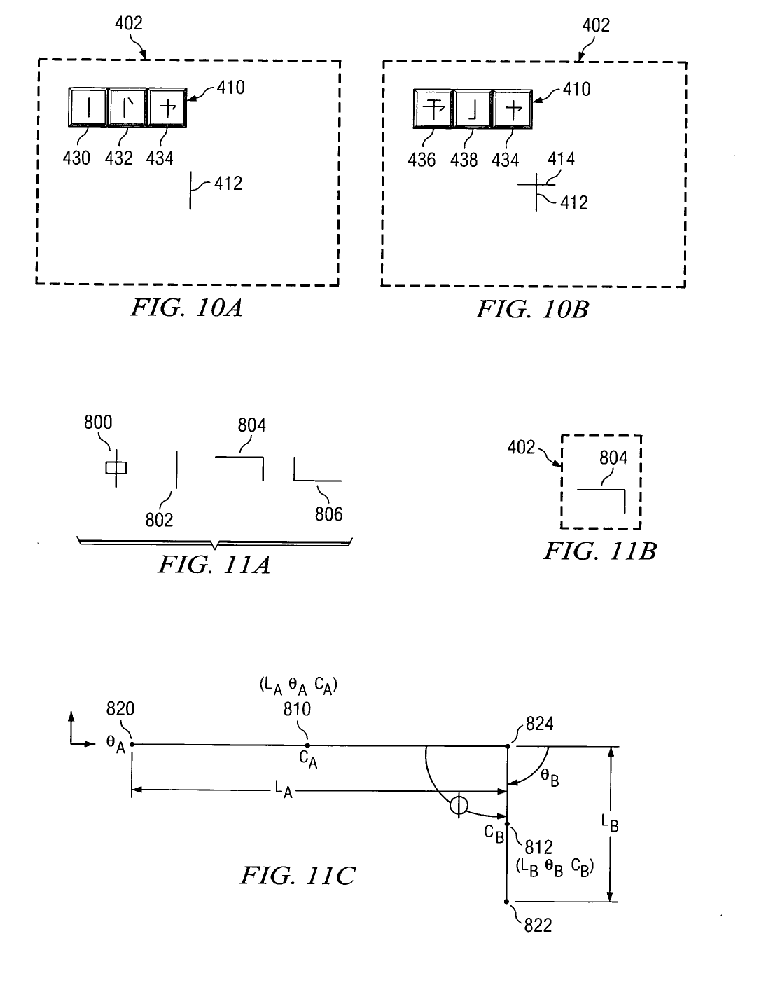

With reference now to FIG. 10A, a diagrammatic illustration of capture area 402 and candidate display 410 is shown after user input of a first stroke 412 of character 406. A stroke parameter set for stroke 412 is calculated by the client and communicated to data processing system 200 for identification of candidate characters. Data processing system 200 interrogates the reference character dictionary with the stroke parameter set and identifies one or more candidate characters based on a comparison of the stroke parameter set and reference parameter sets of records 720-725. The candidate characters identified by data processing system 200 are communicated to the client for output in candidate display 410. In the illustrative example, three candidate characters 430, 432, and 434 have been identified and are displayed in candidate display 410. If a candidate character identified by system 200 matches the character being input to the client, the user is able to select the correct candidate character in candidate display 410. In the present example, none of the candidate characters identified after input of stroke 412 match character 406 being written by the user.

With reference now to FIG. 10B, a diagrammatic illustration of capture area 402 and candidate display 410 after user input of first and second strokes 412 and 414 of character 406 is shown. A stroke parameter set for stroke 414 is calculated by the client and communicated to system 200 for an additional interrogation of reference character dictionary 700. Data processing system 200 interrogates reference character dictionary 700 with the stroke parameter set calculated by the client from stroke 414 and identifies one or more candidate characters. The candidate characters identified by data processing system 200 are communicated to the client for output in candidate display 410. In the illustrative example, candidate characters 430 and 432 have been eliminated as candidates after the second interrogation of the reference character dictionary and new candidate characters 436 and 438 have been identified and communicated to the client for output in candidate display 410. Candidate character 436 matches the character being supplied to capture area 402. The user confirms that candidate character 436 matches the character being entered by, for example, positioning the pointer within the display area of candidate character 436 and providing an input to the mouse. Alternatively, candidate characters 434, 436 and 438 may be selected by the user through a quick select function implemented by the stroke collection algorithm. For example, candidate characters displayed in candidate display 410 may be logically associated with a keyboard key by the stroke collection algorithm. Selection of a respective keyboard key, for example a numerical key “1,” “2,” and “3,” associated with candidate character 434, 436 and 438 results in a confirmation of the candidate character as a match with the character being entered. Other mechanisms for confirming a match between a candidate character and the character being entered at the client may be suitable substituted. The client provides a confirmation message to system 200 upon supply of the confirmation input by the user. Preferably, the candidate character selected by the user from candidate display 410 is then displayed in collection area 402 and an audio playback of the selected character may be output by data processing system 200. The user may then begin input of an additional character within capture area 402.

In accordance with another embodiment of the invention, the stroke collection algorithm may detect directional changes in a single stroke and partition the stroke into multiple logical strokes in accordance with a preferred embodiment of the invention. As referred to herein, a logical stroke refers to a portion, or segment, of a stroke that is partitioned from a single physical stroke and that is analyzed as if the stroke partition is a complete handwritten stroke. FIG. 11A is a Chinese character 800 that when properly written requires three constituent strokes 802, 804, and 806. The right angles of strokes 804 and 806 do not facilitate nominal length, angle and center parameter calculations by analysis of stroke start and end points. For example, a length parameter calculation made according to start and end points of stroke 804 would not provide a desirable estimate of the stroke length. Additionally, users not extensively familiar with the Chinese language may write strokes 804 and 806 as incorrectly including two strokes each. Other users may incorrectly write strokes 804 and 806 together in a single physical stroke.

Next, FIG. 11B illustrates stroke 804 entered into capture area 402 as a single physical stroke. In accordance with an embodiment of the invention, a stroke in which the directional motion of the pointing device changes in an amount equal or exceeding a threshold, for example 90 degrees, during input of the stroke is divided into multiple logical strokes.

FIG. 11C illustrates an exemplary partitioning of stoke 804 as implemented according to a preferred embodiment of the invention. Stroke start and end points 820 and 822 are identified and coordinates are obtained for each of the start and end points 820 and 822. Additionally, the stroke collection algorithm detects a change in the stroke trajectory and partitions stroke 804 into multiple logical strokes 810 and 812. In the illustrative example, a trajectory change of 4 is detected equivalent to a predefined trajectory threshold of 90 degrees. Stroke 804 is partitioned into logical strokes 810 and 812 by the stroke collection algorithm.

Stroke parameters are calculated for each of logical strokes 810 and 812 responsive to detection of a pointer trajectory change equal or exceeding the trajectory threshold. Pursuant to identification of stroke 804 as including logical strokes 810 and 812, a partition point 824 is assigned at a stroke position where the stroke trajectory equals or exceeds the trajectory threshold. The partition point 824 is assigned as an end point to logical stroke 810 and as a stroke start point for logical stroke 812. Accordingly, length (LA), angle (ΘA), and center (CA) parameters are calculated for logical stroke 810 based on stroke start point 820 and partition point 824. Similarly, length (LB), angle (ΘB), and center (CB) parameters are calculated for logical stroke 812 based on partition point 824 assigned as a start point and stroke end point 822 of logical stroke 812. In a similar manner, stroke 806 is partitioned into two logical strokes when entered into collection area 402 by the user.

While the examples of FIGS. 11A-11C illustrate stroke 804 being partitioned into two logical strokes 810 and 812, the partitioning example shown and described is exemplary only. A single physical stroke may be partitioned into any number of logical strokes. The number of logical strokes into which a stroke is partitioned is dependent on the trajectory threshold and changes in the trajectory of a stroke supplied to capture area 402.

Pursuant to enabling partitioning of handwritten character strokes into multiple logical strokes, the reference parameter sets of reference character dictionary 700 may describe attributes of logical strokes when appropriate. For example, record 725 is an exemplary character entry of the reference character dictionary for the character shown in FIG. 11A. Notably, the stroke number maintained in the stroke field is a stroke count that includes logical strokes. The character defined by record 725 and described in FIG. 11A requires three handwritten strokes when properly written. However, the stroke number of record 725 specifies a stroke count of five. The stroke count of stroke field 712 of the reference character dictionary is the sum of the particular reference character strokes that do not require trajectory changes equal or exceeding the trajectory threshold and the number of logical strokes of any physical strokes that require trajectory changes equal or exceeding the trajectory threshold.

Accordingly, character entry 725 has five reference parameter sets—one that describes a physical stroke and four that describe logical strokes. Each stroke, whether physical or logical, includes a corresponding reference parameter set field with a reference stroke parameter set that is compared against stroke parameter sets calculated by the client.

The ability to identify a correct candidate character is enhanced by partitioning character strokes into logical strokes. For example, character 800 properly written as three strokes 802, 804, and 806 is partitioned into a total of five strokes and corresponding stroke parameter sets are calculated for each of the physical and logical strokes. Moreover, character 800 may be written improperly with two strokes or five strokes. In each instance, a total of five strokes are identified by the client and stroke parameter sets for each of the five strokes are calculated. Thus, partitioning strokes of a handwritten character into logical strokes facilities accurate candidate character identification when a character is written properly or improperly.

As described, the present invention provides techniques for deriving stroke parameters from character strokes input by the user. The stroke parameters are calculated from stroke start and end points thereby reducing the amount of stroke data needed for performing a handwriting analysis. The stroke parameters can be contained in data sets smaller than handwriting sample data required for pointing reference character dictionary interrogations. Handwritten strokes are partitioned into logical strokes and stroke parameters are determined for the logical strokes. Calculation of stroke parameters is facilitated by partitioning strokes having trajectory changes in excess of a predetermined trajectory threshold into logical strokes. A network-based handwriting recognition implementation is facilitated by reducing the amount of data required for performing handwriting recognition.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for performing handwritten character recognition, the method comprising the computer implemented steps of:
responsive to user input to a pointing device entered through a computer interface, identifying a stroke start event and a stroke end event;
deriving a stroke parameter from the stroke start event and the stroke end event;
transmitting the stroke parameter to a server; and
receiving a candidate character from the server, wherein the candidate character is based on the stroke parameter.

2. The method according to claim 1, wherein the stroke start event is a depression of a pointing device button, and the stroke end event is a release of the pointing device button.

3. The method according to claim 1, wherein the step of identifying includes:
determining a coordinate of a pointing device icon upon identification of the stroke start event, and determining a coordinate of the pointing device icon upon identification of the stroke end event.

4. The method according to claim 1, wherein the deriving step includes:
calculating a plurality of stroke parameters from the stroke start event and the stroke end event.

5. The method according to claim 1, wherein the deriving step includes:
calculating at least one of a stroke length, stroke angle, and a stroke center for the stroke parameter.

6. The method according to claim 1, further comprising:
downloading a web page from the server.

7. The method according to claim 6, further comprising:
receiving a match confirmation input indicating the candidate character corresponds to a character being input to the computer interface; and
communicating the match confirmation input to the server.

8. The method according to claim 7, further comprising:
responsive to determining the candidate character, transmitting the candidate character to the first computer.

9. A computer program product in a computer readable medium for performing handwriting recognition comprising:
first instructions for displaying a collection area in a computer interface and adapted to determine a start point and an end point of a stroke input into the collection area, the first instructions, responsive to determination of the start point and the end point, calculating a stroke parameter set describing attributes of the stroke;
a reference character dictionary including a plurality of records each defining a respective reference character; and
second instructions, responsive to a comparison of the stroke parameter set with the plurality of records, for identifying at least one reference character as a candidate character.

10. The computer program product according to claim 9, wherein the computer interface includes a candidate display for displaying the candidate character identified by the second instructions.

11. The computer program product according to claim 9, wherein the candidate character displayed in the candidate display is selectable by the user, the first instructions communicating selection of the candidate character to the second instructions.

12. The computer program product according to claim 9, wherein the stroke parameter set includes a length parameter, an angle parameter and a center parameter.

13. The computer program product according to claim 12, wherein each of the plurality of records include at least one reference parameter set having a length parameter, an angle parameter, and a center parameter, the comparison includes comparing the length, angle, and center parameters of the stroke parameter set with the length, angle, and center parameters, respectively, of the plurality of records.

14. The computer program product according to claim 9, wherein the first instructions, responsive to a change in trajectory of the stroke input into the collection area of at least a trajectory threshold, determine a partition point, a first stroke parameter set calculated from the start point and the partition point and a second stroke parameter set calculated from the partition point and the end point.

15. The computer program product according to claim 14, wherein identification of the at least one candidate character is made by comparison of the first stroke parameter set and the second stroke parameter set with the plurality of records.

16. A data processing system comprising:
a pointing device;
a display;
a memory that contains a set of instructions; and
a processing unit, responsive to execution of the set of instructions, for providing a computer interface that identifies a start point and an end point of a handwritten character stroke input to the pointing device, a first stroke parameter set calculated by the processing unit responsive to identification of the start point and the end point.

17. The data processing system of claim 16, further comprising a network adapter for connecting the data processing system to a network computer, the set of instructions communicated to the data processing system responsive to connection of the data processing system with the network computer.

18. The data processing system according to claim 16, wherein the first stroke parameter set includes a length parameter, an angle parameter, and a center parameter.

19. The data processing system according to claim 16, wherein the processing unit, responsive to a change in trajectory of the pointing device of at least a trajectory threshold, calculates a second stroke parameter set.

20. The data processing system according to claim 16, wherein the computer interface includes a candidate display for displaying a candidate character identified by comparison of the first stroke parameter set with a reference parameter set of a reference character dictionary.
